(19) United States
(12) Patent Application Publication
(10) Pub. No.: US 2007/0139280 A1
(43) Pub. Date: Jun. 21, 2007

(54) Switchable planar antenna apparatus for quad-band GSM applications

(76) Inventor: Scott LaDell Vance, Staffanstorp (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/359,896

(22) Filed: Feb. 17, 2006

Related U.S. Application Data
(60) Provisional application No. 60/750,863, filed on Dec. 16, 2005.

(51) Int. Cl. H01Q 1/24

(52) U.S. Cl. 343/702; 343/906

(57) ABSTRACT

An antenna apparatus for a wireless electronic device includes an antenna radiation device that is operable to transmit and/or receive electromagnetic waves in one or more frequency bands concurrently, and an antenna feeding device which is operable to transmit and/or receive electrical data from and/or to the antenna radiation device. Furthermore, the antenna radiation device includes a joint antenna device, wherein the joint antenna device comprises a high-band antenna device and a low-band antenna device and is operable to transmit and/or receive electromagnetic waves in a low- and a high-frequency band concurrently and to switch to different predetermined frequency bands of the high-band antenna device and/or low-band antenna device. Furthermore, the antenna feeding device includes at least three contacts operable for connecting one radio frequency source, at least one ground contact and at least one impedance matching. Favorably this antenna apparatus is operable for quad-band GSM (Global Systems of Mobile Communications) applications.

### CROSS REFERENCE TO RELATED APPLICATION

This application claims priority under 35 U.S.C. §119 to U.S. Provisional Application No. 60/750,863, filed Dec. 16, 2005, the entire disclosure of which is incorporated herein by reference.

### TECHNICAL FIELD OF THE INVENTION

The present invention relates to the field of antenna for mobile systems and particularly to transmitting and receiving planar antenna design for Global System for Mobile Communications (GSM) Applications.

### DESCRIPTION OF RELATED ART

GSM is a mobile phone standard for digital communication whose frequencies are specified since the year 1990. GSM communication systems basically cover frequencies in a range around 850 MHz, 900 MHz, 1800 MHz and 1900 MHz. The frequencies at 850 MHz are refereed to as GSM850 or GSM800. The frequencies at 900 MHz are refereed to as GSM900 or E-GSM-Band (Extended GSM) since only 890 MHz to 915 MHz and 935 MHz to 960 MHz were originally intended (P-GSM) for GSM systems. Another renaming took place for the formerly called DCS-Band (Digital Cellular System) and the PCS-Band (Personal Communication System), which were implemented after the GSM850 and GSM900 standard and are now called GSM1800 and GSM1900, respectively. Furthermore the frequencies of GSM850 and GSM900 have a higher range compared to the frequencies of GSM1800 and GSM1900 due to their longer wavelengths and thus the lower dispersion. All these GSM frequencies address wireless networking and communication of portable and mobile computing devices such as Personal Computers (PC), Personal Digital Assistants (PDA), peripherals, cell phones, pagers, and consumer electronics; allowing these devices to communicate and interoperate with one another via a base station, respectively. The United States and Canada utilize the GSM communication frequencies only at around 850 MHz and 1900 MHz, while Europe utilizes mainly 900 MHz and 1800 MHz for mobile communications. For better understanding, GSM850 and GSM900 are defined as part of a low-band frequency, while GSM1800 and GSM1900 are defined as part of a high-band frequency.

The state of the art regarding U.S. Pat. No. 6693594 discloses an antenna apparatus which is capable to emit and/or receive frequencies in all four frequency bands and to switch between the lower bands GSM850 and GSM900. The major drawback to this solution is that the low-band bandwidth may be narrow and ESD (Electro-Static Discharge) can be conducted to the switching device. Most currently known low-loss switches are very sensitive to ESD.

Furthermore U.S. Pat. No. 6034636 discloses a switching antenna apparatus wherein multiple ground paths are advantageously used overcoming the ESD issues. However, the antenna presented is not robust for multi-band applications. The apparatus is simple and could only handle one or two bands without significant modification.

Furthermore the Motorola C650 is interesting since it switches a single ground point in contrast to U.S. Pat. No. 6693594 switching two ground points. However, radiated testing indicates that this antenna has very poor performance, especially in the low-band and against the users head (−13 dB). A more robust concept with better performance is needed.

### SUMMARY

In view of the aforementioned shortcomings associated with previous antennas for mobile systems, there is a strong need in the art for an antenna apparatus operable in all four frequencies to allow access to mobile communication services with only one device in different countries providing the above-mentioned frequencies. Moreover, there is a strong need for an antenna apparatus which could save power. Since not all frequencies are available in one country, concurrently emitting all four frequencies would unnecessarily waste a lot of battery power. Still further, there is a strong need in the art for an antenna apparatus which is small and features a certain robustness against electrodynamic influences and concurrent precision during the applications in the frequency bands. Still further, there is a strong need for an antenna apparatus operable to output a good performance.

The present invention provides an antenna apparatus for a wireless electronic device comprising an antenna radiation device operable to transmit and/or receive electromagnetic waves in one or more frequency bands concurrently, and an antenna feeding device operable to transmit and/or receive electrical data from and/or to the antenna radiation device, wherein the antenna radiation device comprises an joint antenna device, wherein the joint antenna device comprises a high-band antenna device and a low-band antenna device and is operable to transmit and/or receive electromagnetic waves in a low- and a high-frequency band concurrently and switch to different predetermined frequency bands, wherein the antenna feeding device comprises at least one contact operable for connecting one radio frequency source, at least one ground contact and at least one contact for impedance matching.

Advantageously the joint antenna apparatus is formed as two branches.

Advantageously the joint antenna apparatus is formed as a loop, wherein at least a part of the loop comprises a meander formed portion.

Advantageously the joint antenna apparatus is formed as a loop, wherein the low-band antenna apparatus is formed as a bulk portion and the high-band antenna apparatus as a branch.

Advantageously the antenna radiation device comprises a parasitic antenna device operable to couple with the joint antenna device to transmit and/or receive electromagnetic waves in a predetermined high-frequency band.

Advantageously the antenna apparatus is operable to transmit and/or receive electromagnetic waves in the frequency bands of the Global System of Mobile Communications (GSM).

Advantageously the frequency bands comprise at least GSM850, GSM900, GSM1800 and GSM1900.

Advantageously a transmission and/or reception apparatus comprises above-mentioned antenna apparatus and an antenna feeding circuitry device operable to switch the impedance matching and to send and/or receive electrical data from and/or to the antenna apparatus.

Advantageously the antenna feeding circuitry device comprises an circuitry contact device operable to form a connection with the antenna contact device, a radio frequency source device operable to send and/or receive electrical data from and/or to the antenna apparatus, a ground contact operable to ground electrical devices of the antenna apparatus and/or the antenna feeding circuitry device and an impedance matching device operable to change the impedance matching of the antenna apparatus and to select a desired frequency band thereby.

Advantageously the impedance matching device comprises a plurality of impedances, the ground contact and a switching device operable to connect with the plurality of impedances. Advantageously a wireless electronic device comprises an above-mentioned transmission and/or reception apparatus, operable to execute a diverse number of different electronic tasks and to establish a connection via the transmission and/or reception apparatus to other wireless electronic devices having a transmission and/or reception apparatus.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following description the invention will be explained in more detail in relation to the enclosed drawings, in which

FIG. 1 shows a schematical view of an example of a transmission and/or reception apparatus comprising an embodiment of antenna apparatus of the present invention,

FIG. 2 shows an embodiment of the present invention on a layout of a printed circuit board (PCB),

FIG. 3 shows a schematical view of an example of an antenna feeding circuitry device,

FIG. 4 shows an alternative embodiment of the present invention on a layout of a printed circuit board (PCB),

FIG. 5 shows a schematical view of an alternative example of an antenna feeding circuitry device,

FIG. 6 shows an alternative embodiment of the present invention on a layout of a printed circuit board (PCB),

FIG. 7 shows a schematic view of an alternative example of an antenna feeding circuitry device.

### DETAILED DESCRIPTION OF EMBODIMENT

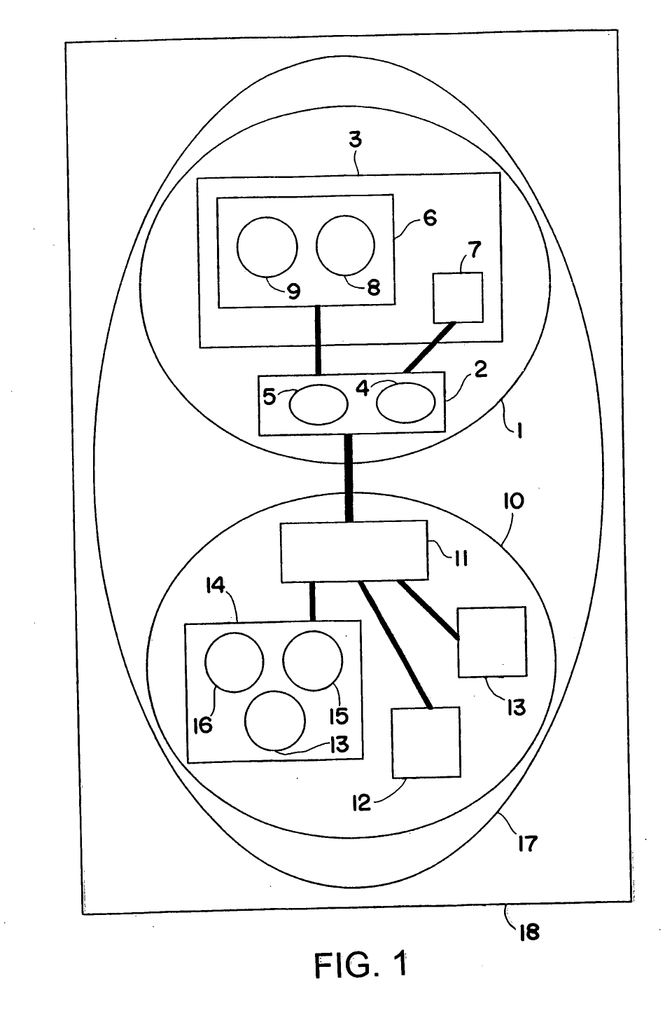

FIG. 1 shows a schematical view of an example of a wireless electronic device 18 comprising a transmission and/or reception apparatus 17 comprising an embodiment of antenna apparatus 1 and an example of an antenna feeding circuitry device 10. The wireless electronic device 18 is operable to execute a diverse number of different electronic tasks and to establish a connection via the transmission and/or reception apparatus 17 to other wireless electronic devices having a transmission and/or reception apparatus 17. This wireless electronic device 18 comprises portable and mobile computing devices such as Personal Computers (PC), Personal Digital Assistants (PDA), peripherals, cell phones, pagers and consumer electronics.

The transmission and/or reception apparatus 17 is operable for the emission and reception of electromagnetic waves and data as well as the selection of the frequency band as well as to form a; connection with other transmission and/or reception apparatus 17.

The antenna apparatus 1 comprises an antenna feeding device 2 and an antenna radiation device 3. The antenna apparatus 1 is planar and operable to receive and/or send data and to receive and/or send electromagnetic waves in frequencies in one or more frequency bands concurrently. Favorable the antenna apparatus 1 is working in the frequency bands of GSM applications but can also be setup for any other frequencies operable to transmit and/or receive data. Also the processing is favorably done by photo lithographic means but is not limited to any processing methods.

The antenna feeding device 2 comprises antenna contact device 4 and antenna contact extension device 5. The antenna feeding device 2 is connected with the circuitry device 10 and the antenna radiation device 3, in particular with the parasitic antenna device 7 and the joint antenna device 6 and is operable to conduct electrical information from the antenna radiation device 3, via the antenna contact extension device 5 and via the antenna contact device 4 to the circuitry device 10 and/or the other way around.

The antenna contact device 4 is operable to form a connection with the outlying antenna feeding circuitry device 10, particularly by means of the circuitry contact device 11 of the antenna feeding circuitry device 10. Thus, electrical information is exchanged between the antenna apparatus 1 and the antenna feeding circuitry device 10.

The antenna contact extension device 5 is operable to form a connection with the antenna contact device 4 and the antenna radiation device 3.

The antenna radiation device 3 comprises a parasitic antenna device 7 and a joint antenna device 6. The antenna radiation device 3 is operable to convert electrical data into electromagnetic waves and the other way around and for the transmission and/or reception of the electromagnetic waves of all frequencies the antenna apparatus 1 is designed for. Due to the later described design of the antenna radiation device 3 and of the impedance matching 14 a specific frequency attenuation is achieved.

The parasitic antenna device 7 is interacting with the joint antenna device 6 in a way and is operable to define a frequency which is not changing due to impedance switching. Favorably the parasitic antenna device 7 defines a frequency in the high-band but can be designed for any other frequency used for specific applications. The parasitic antenna device 7 is connected with the antenna feeding device 2, particularly with the antenna contact extension device 5.

The joint antenna device 6 is connected to the antenna feeding device 2, in particular with the antenna contact extension device 5 and furthermore comprises a high-band antenna device 8 and a low-band antenna device 7. The RF (radio frequency) source device 12 sends electrical information to the joint antenna device 6.

The high-band antenna device 8 is operable to receive and/or send electromagnetic waves in the high-band frequency. The high-band antenna device 8 is tunable as explained in the later described embodiments of the present invention.

The low-band antenna device 9 is operable to receive and/or send electromagnetic waves in the low-band frequency. The low-band antenna device 9 is tunable as explained in the later described embodiments of the present invention.

The antenna feeding circuitry device 10 comprises a circuitry contact device 11, a ground contact 13, a RF (radio frequency) source device 12 and an impedance matching device 14. The antenna feeding circuitry device 10 is operable to send and/or receive electrical information from and/or to the antenna apparatus 1. Furthermore, it is operable to switch the impedance matching. Later on, more detailed features of the operation of the antenna feeding circuitry device 10 regarding the circuitry contact device 11, the ground contact 13, the RF source device 12 and the impedance matching device 14 will be described.

The circuitry contact device 11 is operable to form a connection with the outlying antenna apparatus 1, particularly by means of the antenna contact device 4 of the antenna apparatus 1. Thus, electrical information is exchanged between the antenna apparatus 1 and the antenna feeding circuitry device 10.

The RF source device 12 is connected to the circuitry contact device 11 and is operable to send and/or receive electrical information from and/or to the antenna apparatus 1.

The ground device 13 is connected to the circuitry contact device 11 and is operable to ground electrical parts of the antenna apparatus 1 and/or the antenna feeding circuitry device 10 and/or the transmission and/or reception apparatus 17.

The impedance matching device 14 comprises a switching device 15, a plurality of impedances 16 and an above described ground device 13. The impedance matching device 14 is connected to the circuitry contact device 11 and is operable to change the impedance of the antenna apparatus 1 and to select a desired frequency thereby.

The switching device 15 is operable to connect in a specific way with the plurality of impedances 16, the ground device 13 and/or the circuitry contact device 11 and to switch between the different by different impedance devices 16 generated values and form a specific frequency attenuation for the transmission and/or reception apparatus 17.

The plurality of impedance devices 16 is operable to connect in a specific way with the switching device 15, the ground device 13 and/or the circuitry contact device 11. The impedance devices 16 differ in their value from each other to realize different impedance matching and thereby different operational frequencies of the transmission and/or reception apparatus 17.

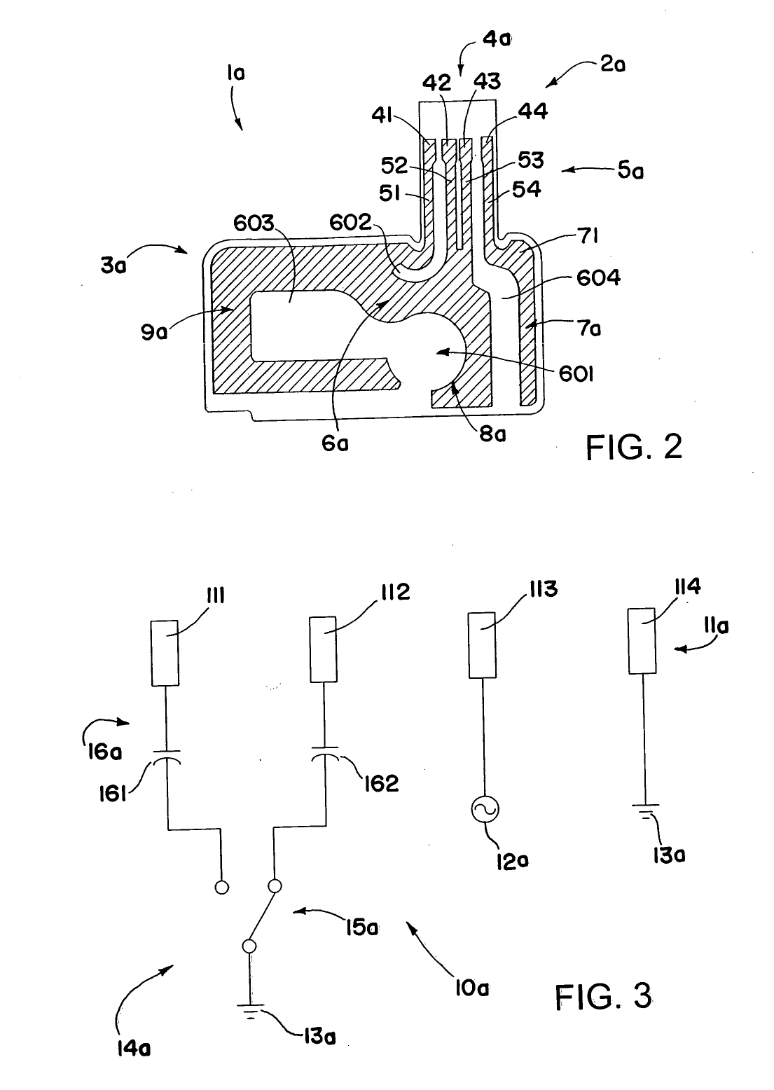

FIG. 2 shows an embodiment of the present invention on a layout of a printed circuit board (PCB). The antenna apparatus 1a comprises an antenna feeding device 2a and an antenna radiation device 3a. The antenna apparatus 1 a and all in FIG. 2 described devices are the same as described in FIG. 1.

The antenna feeding device 2a is perpendicular aligned to the top right side of the antenna radiation device 3a and comprises an antenna contact device 4a and an antenna contact extension device 5a. The antenna feeding device 2a has a rectangular border. The antenna contact device 4a comprises four antenna contacts 41, 42, 43, 44 which are arranged in one line parallel to the top side of the antenna radiation device 3a. The antenna contact extension device 5a comprises four parallel arranged antenna contact extensions 51, 52, 53, 54 which are connected to the antenna contacts 41, 42, 43, 44, respectively. Furthermore, antenna contact extension 54 is connected to the parasitic antenna device 7a, while the antenna contact extensions 51, 52, 53 are connected to the joint antenna device 6a. The distance between the antenna contact extension 52 & 53 is smaller than the distance between the antenna contact extension 51 & 52 and 53 & 54, respectively. While the antenna contact extensions 52, 53 interconnect with each other right at the edge of the joint antenna device 6a, the antenna contact 15 extension 51 is kept separate by a gap 602 from merging with the other antenna contact extensions 52, 53. The gap 602 is curved and has a equidistant width. It is noted that the relations of the sizes are no limiting but favorable features of the subject-matter and can be changed by a person skilled in the art.

The antenna radiation device 3a has a rectangular border wherein the bottom of right side is more extended downwards than the bottom of the left side. Furthermore the upper corners are curved shaped while the lower ones are more angular. The antenna radiation device 3a comprises a parasitic antenna device 7a, a joint antenna device 6a and a gap 604 which separates the parasitic antenna device 7a and the joint antenna device 6a from each other. The gap 604 is parallel and narrows in a S-bend shaped way right before connecting with the antenna feeding device 2a and merging with the gap between the antenna contact extension 53 & 54. The gap 604 is open at the bottom and at the top of the antenna radiator device 3a.

The parasitic antenna device 7a extends with a equidistant width straight from the bottom right side of the antenna radiation device 3a to its top side, narrows in a S-bend shaped way right before connecting with the antenna feeding device 2a and merges with the antenna contact extension 54. At the upper right corner and right before narrowing towards the antenna feeding device 2a the parasitic antenna device 7a comprises a bump 71 which is bigger than the width of the parasitic antenna device 7a. In this embodiment the parasitic antenna device 7a is operable in the DCS (or GSM1800 called) frequency band.

The joint antenna device 6a comprises a high-band antenna device 8a, a low-band antenna device 9a, a gap 602 as mentioned above, a rectangular shaped space 603 and a round shaped space-artifact 601. The high-band antenna device 8a extends from the antenna feeding device 2a, in particular from the two joint antenna contact extensions 52 & 53, down to the bottom of the antenna radiator device 3a. The left side of the high-band antenna device 8a envelopes the right half side of the round shaped space-artifact 601. The width of the high-band antenna device 8a is larger than or equal to the width of the parasitic antenna device 7a. The lower end of the high-band antenna device 8a is straight and arranged at the same height as the one of the parasitic antenna device 7a. In this embodiment the high-band antenna device 8a is operable in the PCS (or GSM1900 called) frequency band. The low-band antenna device 9a extends from the antenna feeding device 2a, in particular from the two joint antenna contact extensions 52 & 53 and the antenna contact extensions 51 which are separated by the gap 602 as previously mentioned, straight to the left of the antenna radiator device 3a. The width of the upper side of the low-band antenna device 9a is larger than or equal to the width of the high-band antenna device 8a perpendicular to round side. Then continuing from the left upper corner the low-band antenna device 8a extends straight downwards with a width smaller than the prior portion. At the height of the bottom side of the space-artifact 601 the low-band antenna device 9a extends straight right with a width smaller than the prior portion until the right side of the low-band antenna device 9a partially envelopes the space-artifact 601. Except for one side open to the space-artifact 601 the space 603 is likewise rectangular enveloped by the low-band antenna device 9a.

FIG. 3 shows a schematical view of an example of an antenna feeding circuitry device 10a comprising a circuitry contact device 11a, a ground contact 13a, a RF source device 12a and an impedance matching device 14a. The antenna feeding circuitry device 10a and all in FIG. 3 described devices are the same as described in FIG. 1. The antenna feeding circuitry 10a is operable to connect to the antenna apparatus 1a described in FIG. 2.

The circuitry contact device 11a comprises four circuitry contacts 111, 112, 113, 114. The circuitry contacts 111, 112, 113, 114 are operable to form a connection with the antenna contacts 41, 42, 43, 44 of FIG. 2, respectively. The impedance matching device 14a comprises a ground contact 13a, a switching device 15a and the impedances 16a comprising the capacity 161 with 33 pF and the capacity 162 with 22 pF. The ground contact 13a is connected to the switching device 15a which selects one of the impedances 16a. Impedance 161 is connected to the circuitry contact 111 and the impedance 162 is connected to the circuitry contact 112. The RF source device 12a is connected to the circuitry contact 113 and the ground contact 13a is connected to the circuitry contact 114.

In combination with the embodiment of the present invention described in FIG. 2, the antenna apparatus 1a is operable to emit and/or receive frequencies always at GSM1800 and GSM1900 and to switch between either GSM850 or GSM900. GSM850 is achieved by connecting with capacity 162 and GSM900 is achieved by connecting with capacity 161. VSWR (voltage standing wave ratio) for low-band is approximately 3:1.

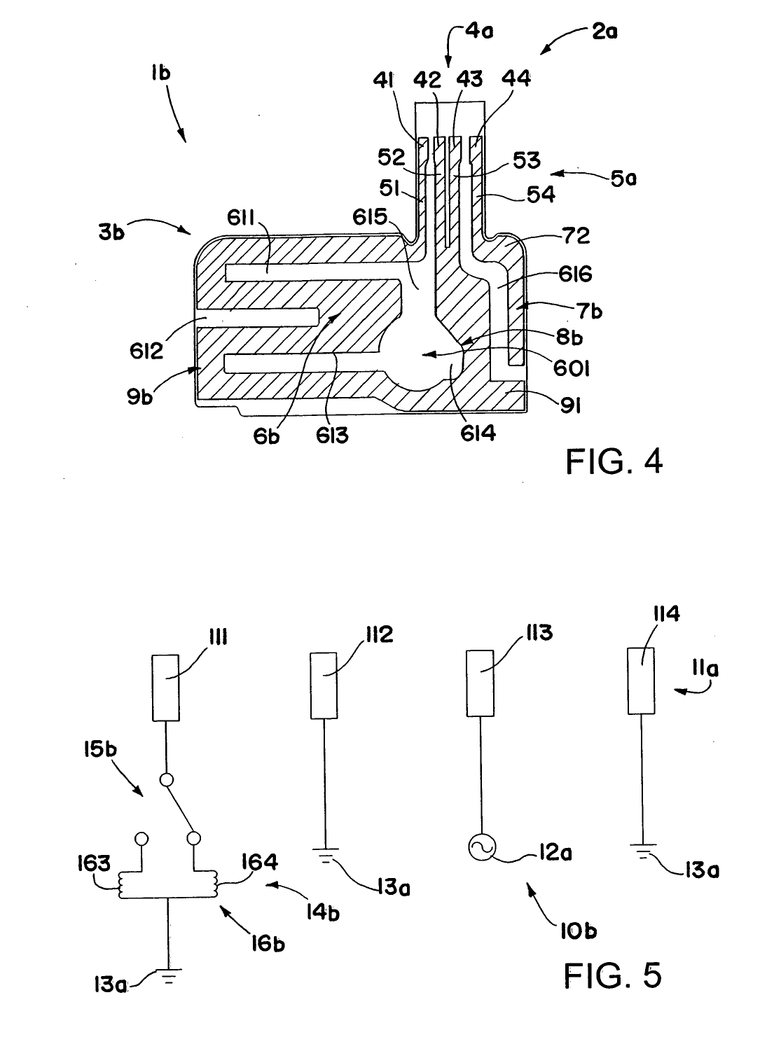

FIG. 4 shows an alternative embodiment of the present invention on a layout of a printed circuit board (PCB). The antenna apparatus 1b comprises an antenna feeding device 2a and an antenna radiation device 3b. The antenna apparatus 1b and all in FIG. 4 described devices are the same as described in FIG. 1. Except for the gaps 602 and 604 the antenna feeding device 2a is also the same as described in FIG. 2. In this embodiment the gaps between the antenna contact extensions 51 & 52 and 53 & 54 lead to the gaps 615 and 616, respectively.

The antenna radiation device 3b has a rectangular border wherein the bottom of right side is more extended downwards than the bottom of the left side. Furthermore the upper corners are curved shaped while the lower ones are more angular. The antenna radiation device 3b comprises a parasitic antenna device 7b, a joint antenna device 6b and a gap 616 which separates the parasitic antenna device 7b and the joint antenna device 6b from each other. The gap 616 has an equidistant width and narrows less compared to the gap 604 in FIG. 2, since the maximum width of gap 616 is smaller than the one of gap 604. The gap 616 is only shaped in a S-bend shaped way right before connecting with the antenna feeding device 2a and merging with the gap between the antenna contact extension 53 & 54. The gap 616 is open at the top and right side of the antenna radiator device 3a. The gap 616 comprises a sharp break before exiting to the right side.

The parasitic antenna device 7b extends with a equidistant width straight from the lower right side, limited by the gap 616, of the antenna radiation device 3b to its top side, narrows in a S-bend shaped way right before connecting with the antenna feeding device 2a and merges with the antenna contact extension 54. At the upper right corner and right before narrowing towards the antenna feeding device 2a the parasitic antenna device 7b comprises a bump 72 which is locally enlarging the width of the parasitic antenna device 7b. In this embodiment the resonance frequency of the parasitic antenna device 7b is centered around 1990 MHz.

The joint antenna device 6b is looped shaped, cut on the upper side between the antenna contact extensions 51 & 52 and comprises a high-band antenna device 8b, a low-band antenna device 9b, a gap 615 as mentioned above, three rectangular shaped gaps 611, 612, 613, an appendix gap 614, a round shaped space-artifact 601, a meander formed shape 92 and an tuning appendix 91. The high-band antenna device 8b is realized by approximately the inner border formed inside the loop of the joint antenna device 6b. The three gaps 611, 612, 613 have the same width and are parallel, equidistant and vertically arranged to each other forming the left side of the joint antenna device 6b as a meander like, folded shape 92. Adjacent to the space-artifact 601 lie on the top side the gap 615, on the right side the appendix gap 614 and to the left side the gap 613. The width of the joint antenna device 6b is larger than or equal to the width of the parasitic antenna device 7b. The rectangular shaped tuning appendix 91 is placed in the lower right corner of the antenna radiation device 3b and is aligned with the joint antenna device 6b. The appendix is operable to tune the length of the loop for the low-band frequency slightly and to add coupling between the loop and the parasitic antenna device 7b. The coupling is used to shift the centering of the high-band frequencies on the Smith chart which is essential for good matching. The low-band antenna device 9b is realized by approximately the outer border formed outside the loop of the joint antenna device 6b. The upper part of the joint antenna device 6b extends from the antenna feeding device 2a, in particular perpendicular from the antenna contact extensions 51, straight to the left of the antenna radiator device 3b. Then continuing from the left upper corner the joint antenna device 6b extends straight downwards as far as to the gap 612, then turns straight right as far as to the gap 615, then extends down while following the border of the space-artifact 601, then turns straight left until being tangent with the vertical line of the above mentioned left part of the joint antenna device 6b and then extends straight downwards until the following right extension has the same width as the prior mentioned horizontal extensions and further as the gap 613 has the same width as the gaps 611 and 612. The last horizontal extension touches and follows the border of the space-artifact 601. Starting from the joint antenna contact extensions 51 & 52 the joint antenna device goes straight down forming the complete right border of the gap 615, partially of the space-artifact 601 and the appendix gap 614, until arriving at the bottom and merging perpendicular with the extension coming from the left side. Again the right bottom portion of the joint antenna device 6b is lower than its left bottom portion. The transition between the two portions is curved.

Moreover, the meander formed portion 92 on the left side of the joint antenna device 6b is operable to induce two resonances; in this embodiment one in the low-band and one in the high-band. Depending on the form and size of the outer and inner border these resonances change.

FIG. 5 shows a schematical view of an alternative example of an antenna feeding circuitry device 10b comprising a circuitry contact device 11a, a ground contact 13a, a RF source device 12a and an impedance matching device 14b. The antenna feeding circuitry device 10b and all in FIG. 5 described devices are the same as described in FIG. 1. The antenna feeding circuitry 10b is operable to connect to the antenna apparatus 1b described in FIG. 4.

The circuitry contact device 11a comprises four circuitry contacts 111, 112, 113, 114. The circuitry contacts 111, 112, 113, 114 are operable to form a connection with the antenna contacts 41, 42, 43, 44 of FIG. 4, respectively. The impedance matching device 14b comprises a ground contact 13a, a switching device 15b and the impedances 16b comprising the inductance 163 with 18 nH and the inductance 164 with 7.5 nH. The ground contact 13a is connected to both of the impedances 16b and the switching device 15b is connected to the circuitry contact 111 and can form at the same time one connection with only one of the inductances. The ground contact 13a is connected to the circuitry contact 112. The RF source device 12a is connected to the circuitry contact 113 and the ground contact 13a is connected to the circuitry contact 114.

In combination with the embodiment of the present invention described in FIG. 4, the antenna apparatus 1b is operable to emit and/or receive frequencies at GSM850 and GSM1800, when inductance 163 is connected, or at GSM900 and GSM1900, when inductance 164 is connected. In this example of FIG. 5 the switching device 15b comprises a SPDT (single pole double through) switch. In a more general example, a more complex switch can be used which allow band optimization of many more bands.

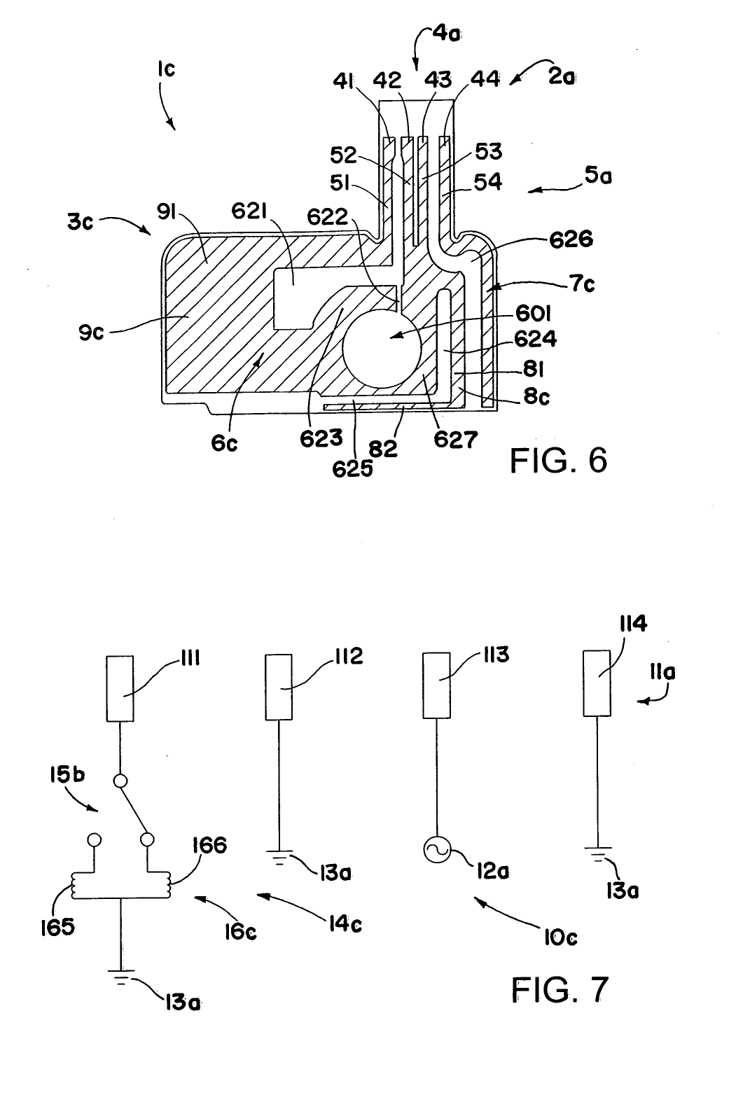

FIG. 6 shows an alternative embodiment of the present invention on a layout of a printed circuit board (PCB). The antenna apparatus 1c comprises an antenna feeding device 2a and an antenna radiation device 3c. The antenna apparatus 1c and all in FIG. 6 described devices are the same as described in FIG. 1. Except for the gaps 602 and 604 the antenna feeding device 2a is also the same as described in FIG. 2. In this embodiment the gaps between the antenna contact extensions 51 & 52 and 53 & 54 lead to the gaps 621 and 626, respectively.

The antenna radiation device 3c has a rectangular border wherein the bottom of right side is more extended downwards than the bottom of the left side. Furthermore the upper corners are curved shaped while the lower ones are more angular. The antenna radiation device 3c comprises a parasitic antenna device 7c, a joint antenna device 6c and a gap 626 which separates the parasitic antenna device 7c and the joint antenna device 6c from each other. The gap 626 has an equidistant width which barely changes in the S-bend shaped shape right before connecting with the antenna feeding device 2a and merging with the gap between the antenna contact extension 53 & 54. The gap 626 is open at the top and bottom side of the antenna radiator device 3c.

The parasitic antenna device 7c extends with a equidistant width straight from the lower right corner of the antenna radiation device 3c to its top side, then forms a S-bend shaped way before connecting with the antenna feeding device 2a and merges with the antenna contact extension 54. The parasitic antenna device 7c has a equidistant width all the time. In this embodiment the parasitic antenna device 7c is tuned for the DCS frequency band.

The joint antenna device 6c is looped shaped, cut on the upper side between the antenna contact extensions 51 & 52 and comprises a high-band antenna device 8c, a low-band antenna device 9c, the gaps 621 and 622, the appendix 623, a bulk 93, a round shaped space-artifact 601 and the gaps 624 and 625. The high-band antenna device 8c comprises the antenna branch 81 and the antenna bottom branch 82 which is perpendicular to the antenna branch 81 and extends to the left at the lower end of the antenna branch 81 until the half of the joint antenna device 6c. The bottom branch 82 is favorable but not necessary to form a high-band antenna device 8c. The low-band antenna device 9c is realized by the bulk 93 of the joint antenna device 6c. The gap 622 is aligned with the top side of the space-artifact 601 and merges on its other side into the gap 621. The low-band antenna device 9c extends from the antenna contact extension 51 perpendicular to the left, then turns straight down with a width larger than the one of the prior extension, then extends perpendicular to the right with a width scaled in between the prior mentioned widths until enveloping the left side of the space-artifact 601. From the upper side of this end a appendix 623 envelops the upper left side of the space-artifact 601 and eventually forms the gap 622. On the contrary, on the lower side of this end a passage 627 smaller than the appendix 623 is form enveloping the space-artifact 601 on the lower and right side. This passage 627 extends upwards connecting with the high-band antenna device 8c and finally with both of the antenna contact extensions 52 & 53.

The appendix 623 couples near the feed and is used to improve the impedance matching in the high and low-band resonances. The joint antenna device 6c is operable to emit and/or receive frequencies in the low-band and DCS and PCS bands.

FIG. 7 shows a schematical view of an alternative example of an antenna feeding circuitry device 10c comprising a circuitry contact device 11a, a ground contact 13a, a RF source device 12a and an impedance matching device 14c. The antenna feeding circuitry device 10c and all in FIG. 7 described devices are the same as described in FIG. 1. The antenna feeding circuitry 10c is operable to connect to the antenna apparatus 1c described in FIG. 6.

The circuitry contact device 11a comprises four circuitry contacts 111, 112, 113, 114. The circuitry contacts 111, 112, 113, 114 are operable to form a connection with the antenna contacts 41, 42, 43, 44 of FIG. 6, respectively. The impedance matching device 14c comprises a ground contact 13a, a switching device 15b and the impedances 16c comprising the inductance 165 with 22 nH and the inductance 166 with 8.2 nH. The ground contact 13a is connected to both of the impedances 16c and the switching device 15b is connected to the circuitry contact 111 and can form at the same time one connection with only one of the inductances. The ground contact 13a is connected to the circuitry contact 112. The RF source device 12a is connected to the circuitry contact 113 and the ground contact 13a is connected to the circuitry contact 114.

In combination with the embodiment of the present invention described in FIG. 6, the antenna apparatus 1c is operable to emit and/or receive frequencies always at GSM1800. Additional frequencies at GSM850 are achieved when inductance 165 is connected or at GSM900 and GSM1900 when inductance 166 is connected.

The terms “electronic device” and “electronic equipment” as referred to herein include portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. An antenna apparatus for a wireless electronic device comprising:
an antenna radiation device operable to transmit and/or receive electromagnetic waves in one or more frequency bands concurrently, and
an antenna feeding device operable to transmit and/or receive electrical data from and/or to the antenna radiation device,
wherein the antenna radiation device comprises an joint antenna device,
wherein the joint antenna device comprises
a high-band antenna device and a low-band antenna device and is operable
to transmit and/or receive electromagnetic waves in a low- and a high-frequency band concurrently and to switch to different predetermined frequency bands of the high-band antenna device and/or low-band antenna device,
wherein the antenna feeding device comprises
at least one contact operable for connecting one radio frequency source, at least one ground contact and at least one contact for impedance matching.

2. An antenna apparatus for a wireless electronic device according to claim 1,
wherein the high-band antenna apparatus and low-band antenna apparatus is formed as a branch, respectively.

3. An antenna apparatus for a wireless electronic device according to claim 1,
wherein the joint antenna apparatus is formed as a loop,
wherein at least a part of the loop comprises a meander formed portion.

4. An antenna apparatus for a wireless electronic device according to claim 1,
wherein the joint antenna apparatus is formed as a loop,
wherein the low-band antenna apparatus is formed as a bulk portion and the high-band antenna apparatus as a branch.

5. An antenna apparatus for a wireless electronic device according to claim 4,
wherein the low-band antenna apparatus comprises an appendix operable to improve the impedance matching of the high-band antenna apparatus and low-band antenna apparatus.

6. An antenna apparatus for a wireless electronic device according to one of the above-mentioned claims,

6. An antenna apparatus for a wireless electronic device according to one of the above-mentioned claims,
wherein the antenna radiation device comprises a parasitic antenna device operable to couple with the joint antenna device to transmit and/or receive electromagnetic waves in an additional predetermined high-frequency band.

7. An antenna apparatus for a wireless electronic device according to the above-mentioned claims,
wherein the antenna apparatus is operable to transmit and/or receive electromagnetic waves in the frequency bands of the Global System of Mobile Communications (GSM).

8. An antenna apparatus for a wireless electronic device according to claim 7,
wherein the frequency bands comprises at least GSM850, GSM900, GSM1800 and GSM1900.

9. A transmission and/or reception apparatus comprising
an antenna apparatus according to the above-mentioned claims and an antenna feeding circuitry device operable to switch the impedance matching and to send and/or receive electrical data from and/or to the antenna apparatus.

10. A transmission and/or reception apparatus according to claim 9,
wherein the antenna feeding circuitry device comprises
an circuitry contact device operable to form a connection with the antenna contact device,
a radio frequency source device operable to send and/or receive electrical data from and/or to the antenna apparatus,
a ground contact operable to ground electrical devices of the antenna apparatus and/or the antenna feeding circuitry device and
an impedance matching device operable to change the impedance matching of the antenna apparatus and to select a desired frequency band thereby.

11. A transmission and/or reception apparatus according to claim 9,
wherein the impedance matching device comprises
a plurality of impedances, the ground contact and
a switching device operable to connect with the plurality of impedances.

12. A transmission and/or reception apparatus according to claim 10,
wherein the impedance matching device comprises
a plurality of impedances, the ground contact and
a switching device operable to connect with the plurality of impedances.

13. A wireless electronic device comprising a transmission and/or reception apparatus according to claim 9,
operable to execute a diverse number of different electronic tasks and to establish a connection via the transmission and/or reception apparatus to other wireless electronic devices having a transmission and/or reception apparatus.

14. A wireless electronic device comprising a transmission and/or reception apparatus according to claim 10,
operable to execute a diverse number of different electronic tasks and to establish a connection via the transmission and/or reception apparatus to other wireless electronic devices having a transmission and/or reception apparatus.

15. A wireless electronic device comprising a transmission and/or reception apparatus according to claim 11,
operable to execute a diverse number of different electronic tasks and to establish a connection via the transmission and/or reception apparatus to other wireless electronic devices having a transmission and/or reception apparatus.

16. A wireless electronic device comprising a transmission and/or reception apparatus according to claim 12,
operable to execute a diverse number of different electronic tasks and to establish a connection via the transmission and/or reception apparatus to other wireless electronic devices having a transmission and/or reception apparatus.
